(19) United States
(12) Patent Application Publication
(10) Pub. No.: US 2006/0291426 A1
(43) Pub. Date: Dec. 28, 2006

(54) Method and apparatus for performing fast handover in wireless network

(75) Inventors: Soo-hong Park, Yongin-si (KR); Young-keun Kim, Incheon (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/473,084

(22) Filed: Jun. 23, 2006

(30) Foreign Application Priority Data
Jun. 28, 2005 (KR) 2005-56444

(51) Int. Cl. H04Q 7/00; H04J 3/24

(52) U.S. Cl. 370/331; 370/349

(57) ABSTRACT

A method and an apparatus of performing a fast handover in a wireless network are provided. The network device includes: a packet generating unit to generate a router solicitation (RS) message including fast handover instruction information, when the network device participates in a new subnet; a packet sending unit to send the generated router solicitation message to a router within the subnet; a packet receiving unit to receive a router advertisement message including handover information necessary to generate an address from the router according to the fast handover instruction information; and a determination unit to generate the address required by the subnet using the handover information.

### CROSS-REFERENCE TO RELATED APPLICATION

This application claims all benefits accruing under 35 U.S.C §119 from Korean Patent Application No. 2005-56444 filed on Jun. 28, 2005, in the Korean Intellectual Property Office, the disclosure of which is incorporated by reference herein.

### BACKGROUND OF THE INVENTION

1. Field of the Invention

Aspects of the invention relate to fast handovers. More particularly, aspects of the invention relate to a method and an apparatus to perform a fast handover in a wireless network environment.

2. Description of the Related Art

Recent improvements in wireless network technologies have increased the application range and frequency of use of mobile wireless computing. In wireless networks, communications are generally performed by infrastructure networks and ad hoc networks. The infrastructure network is similar to a conventional wired local area network (LAN) in that the infrastructure network is configured to be used within fixed areas such as offices or homes. The infrastructure network includes infrastructure, such as an access point or a base station, connected to a wired network and a plurality of wireless nodes that can communicate with the infrastructure.

In contrast, the ad hoc network is configured to communicate by securing a wireless channel between wireless devices (hereinafter referred to as “nodes”), without using a base station or an access point that can be connected to the wired network. A conventional ad hoc network typically has no infrastructure, such as an access point, which can be connected to the wired network, and thus, each node transmits a data packet to a destination node using a routing function. That is, when a node transmits a data packet to a destination node, the data packet is transmitted by way of nodes that can relay the data packet to a designation node. In order to exchange a data packet between nodes, each node constructs a network, allocates an internet protocol (IP) address to itself, verifies that the allocated IP address is unique within the network, and then communicates with another mobile node based on the verified IP address.

Two methods of allocating IP addresses to wireless devices include Internet protocol version 4 (IPv4) and Internet protocol version 6 (IPv6). IPv4 employs a 32-bit address system, which can allocate 2³² addresses or approximately 4 billion addresses. However, due to the development of mobile communication technology, there are relatively few, if any, IPv4 addresses. To address this deficiency in IPv4 addresses, an IPv6 address system has been introduced. IPv6 represents addresses with 128 bits, which can produce 2¹²⁸ addresses.

Compared with a conventional Internet address system, IPv4, the IPv6 address system can produce substantially more addresses. In this respect, it is anticipated that the IPv6 address system can address a lack of IP addresses by IPv4. The IPv6 address system can provide more address fields in a geometric progression. In addition, since the IPv6 address system typically has an integrated security function, a drawback of the Internet protocol possibly being unable to allocate network addresses to individuals can be addressed. It is expected that IPv6 will be utilized in the development of the security market. Thus, research to commercialize the IPv6 address system, as an alternative to the IPv4 address system, in a conventional wireless network, is progressing.

FIG. 1 illustrates a conventional wireless network environment. As illustrated, the environment includes access routers (ARs) and access points (APs), which reside in a wireless network, and mobile nodes (MN), which reside in a predetermined wireless network. A mobile node 1 refers to a network device that moves between a plurality of wireless networks. Access points A 21, B 22 and C 23 connect the mobile node 1 to a sub network (“subnet”) to which each of the access points respectively belongs, to allow the mobile node 1 to access a wired network, such as the Internet. Access routers A 31 and B 32 provide the mobile node 1 with routing services in the respective subnets to which the access routers belong, and functioning to connect the mobile node 1 to an arbitrary node in the subnet along an optimal path.

The conventional wireless network environment is be described under the assumption that the mobile node 1 present in a basic service set (BSS) managed by the access point A 21 passes through a BSS managed by the access point B 22 and a BSS managed by the access point C 23 in sequence, as illustrated FIG. 1. The BSS is a term used in Institute of Electrical and Electronics Engineers (IEEE) 802.11 standard, and the BSS indicates a wireless network region managed by a single access point. The access points A 21, B 22 and C 23 each periodically transmit a beacon signal indicating its BSS in order to inform the mobile node 1 which access point it can use to access the wired network. The mobile node 1 present in the BSS managed by the access point A 21 receives a beacon signal from the access point A 21 denoted by a communication 211. Based on the received beacon signal, the mobile node 1 becomes aware that it is positioned in the BSS managed by the access point A 21. The mobile node 1 accesses the wired network via the access point A 21, as it did previously.

The mobile node 1, whose position has changed, receives a beacon signal from the access point B 22. Based on the received beacon signal, the mobile node 1 becomes aware that the BSS in which it is positioned has changed. Accordingly, the mobile node 1 performs a handover due to the BSS change (i.e., a handover in a link layer). The mobile node 1 knows that it is positioned inside the BSS managed by the access point B 22, and changes a link layer connection with the access point A 21 to a link layer connection with the access point B 22. According to the open systems interconnection (OSI) reference model, since the link layer corresponds to a second layer, a handover in the link layer indicates a handover in the second layer or an “L2 handover”. The mobile node 1 accesses a wired network by way of the new access point B 22, to which it is currently connected.

Thereafter, the mobile node 1 transmits a router solicitation for proxy advertisement (RtSolPr) frame including information that the BSS in which it is positioned has been changed to the access router A 31 via the access point B 22 denoted by a communication 222. The access router A 31 that received this information, not via other access routers, becomes aware that the mobile node 1 is positioned in the subnet that it manages. Thereafter, the access router A 31 transmits a proxy router advertisement (PrRtAdv) frame, which includes information that the subnet has not changed, to the mobile node 1 via the access point A 22 denoted by a communication 223. The mobile node 1 that received this frame becomes aware that it is positioned in the subnet managed by the access router A 31. Accordingly, the mobile node 1 does not perform a handover due to a subnet change, i.e., a handover in an Internet protocol (IP) layer. Referring to the OSI reference model, since the IP layer corresponds to a third layer, a handover in the IP layer is indicated as a “handover in the third layer” or an “L3 handover”.

Thereafter, the mobile node 1 receives a beacon signal from the access point B 22 denoted by a communication 224. Based on the received beacon signal, the mobile node 1 becomes aware that it is positioned in the BSS managed by the access point B 22. The mobile node 1 accesses a wired network by way of the access point B 22, as it did previously. The mobile node 1 receives a beacon signal from the access point C 23 denoted by a communication 231. Based on the received beacon signal, the mobile node 1 becomes aware that the BSS in which it is positioned has changed. Accordingly, the mobile node 1 performs a handover due to the BSS change, i.e., a handover in the link layer. The mobile node 1 becomes aware that it is positioned in the BSS managed by the access point C 23, and changes a link layer connection with the access point B 22 to a link layer connection with the access point C 23. The mobile node 1 accesses a wired network by way of the access point C 23, with which it forms a new connection.

Next, the mobile node 1 transmits an RtSolPr frame, which includes information detailing that the BSS in which it is positioned has changed, to the access router A 31 by way of the access point C 23 and the access router B 32 denoted by a communication 232. The access router A 31 that received this frame via the different access router B 32 becomes aware that the mobile node 1 has left its subnet. The access router A 31 transmits a PrRtAdv frame, which includes information detailing that the subnet in which the mobile node 1 is positioned has changed, to the mobile node 1 via the access router B 32 and the access point C 23 denoted by a communication 233. The mobile node 1 that received this frame becomes aware that the subnet in which it is positioned has changed. Accordingly, the mobile node 1 performs a handover due to the subnet change (i.e., a handover in the IP layer).

As described above, since the mobile node 1 cannot know whether the subnet to which it is connected has changed, the mobile node 1 communicates with an access router in order to obtain information on subnet changes. That is, the mobile node 1 communicates with the access router in order to determine whether to perform a handover only in the link layer, or handovers in both the link layer and the IP layer.

When both handovers in the link layer and the IP layer are performed together according to the communication result, the mobile node 1 generates at operation S200 and transmits at operation S210 a router solicitation (RS) message to the access router B 32 in the concerned wireless network, as illustrated in FIG. 2, in order to request information necessary to generate of an IP address. Having received the router solicitation message at operation S220, the access router B 32 generates a router advertisement (AD) message including information necessary for automatic address setting at operation S230, and transmits it to the concerned mobile node 1 at operation S250. Having received the router advertisement message from the access router B 32 at operation S260, the mobile node 1 automatically sets an address using the information included in the router advertisement message at operation S270.

In a conventional IPv6-based wireless network environment, the router advertisement message typically can be transmitted only after a predetermined delay time. In this regard, a router generates a random number within a predetermined time range N1, and the router advertisement message is transmitted to the concerned mobile node after a delay time corresponding to the random number, to reduce collisions between messages or traffic within the network. However, the random delay can cause unnecessary time delays when generating an address of a mobile node, which can become a significant problem in realizing a fast handover.

### SUMMARY OF THE INVENTION

Accordingly, aspects of the invention promote addressing the above described and other problems. Several example embodiments and aspects of the invention provide a method and an apparatus to perform a fast handover by reducing unnecessary random delay in an IPv6-based wireless network environment.

According to an aspect, among aspects, of the invention, there is provided a network device to perform a fast handover, the network device including: a packet generating unit to generate a router solicitation (RS) message including fast handover instruction information, when the network device participates in a new subnet; a packet sending unit to send the generated router solicitation message to a router within the subnet; a packet receiving unit to receive a router advertisement message including handover information necessary to generate an address from the router according to the fast handover instruction information: and a determination unit to generate the address required by the subnet using the handover information.

According to another aspect, among aspects, of the invention, there is provided a network device to perform a fast handover, the network device including: a packet receiving unit to receive a router solicitation message including fast handover instruction information from a mobile node that participates in a subnet; a packet generating unit to generate a router advertisement message including information necessary to register an address of the mobile node in response to receiving the router solicitation message; a determination unit to check the value of the fast handover instruction information and to selectively perform a random delay; and a packet sending unit to send the router advertisement message to the mobile node.

According to a further aspect, among aspects, of the invention, there is provided a wireless network system including: at least one mobile node, which participates in a new subnet, the mobile node to generate a router solicitation message including fast handover instruction information and to send the fast handover instruction information, and the mobile node to receive a router advertisement message including information necessary to generate an address in response to the router solicitation message, and to generate an address in the subnet; and a router to receive the router solicitation message from the mobile node, to check the value of the fast handover instruction information and to selectively perform a random delay in response to the router advertisement message being sent to the mobile node.

According to a still further aspect, among aspects, of the invention, there is provided a method of executing a fast handover in a wireless network, the method including: generating a router solicitation message including fast handover instruction information; sending the generated router solicitation message to a router within a subnet; receiving a router advertisement message including handover information necessary to generate an address from the router according to the fast handover instruction information; and generating the address using the handover information.

According to a still another aspect, among aspects, of the invention, there is provided a method of executing a fast handover in a wireless network, the method including: receiving a router solicitation message including fast handover instruction information from a mobile node participating in a new subnet; generating a router advertisement message including information necessary to register an address of the mobile node in response to the router solicitation message; and checking the fast handover instruction information and selectively executing a random delay in response to sending the router advertisement message.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional wireless network environment;

FIG. 2 illustrates operations until an address is allocated to a mobile node in the conventional wireless network environment of FIG. 1;

FIG. 3 illustrates a wireless network environment according to an exemplary embodiment of the invention;

FIG. 4 is a block diagram schematically illustrating a configuration of the mobile node according to an exemplary embodiment of the invention;

FIG. 5 illustrates a format of a router solicitation message generated by the mobile node according to an exemplary embodiment of the invention;

FIG. 6 is a block diagram schematically illustrating a configuration of a router according to an exemplary embodiment of the invention;

FIG. 7 illustrates a format of a router advertisement message generated by the router according to an exemplary embodiment of the invention;

FIG. 8 illustrates a concept of a fast handover performed according to an exemplary embodiment of the invention;

FIG. 9 is a flow chart illustrating generation of a router solicitation message by the mobile node in the fast handover according to an exemplary embodiment of the invention; and

FIG. 10 is a flow chart illustrating transmission of the router advertisement message by the router in the fast handover according to an exemplary embodiment of the invention.

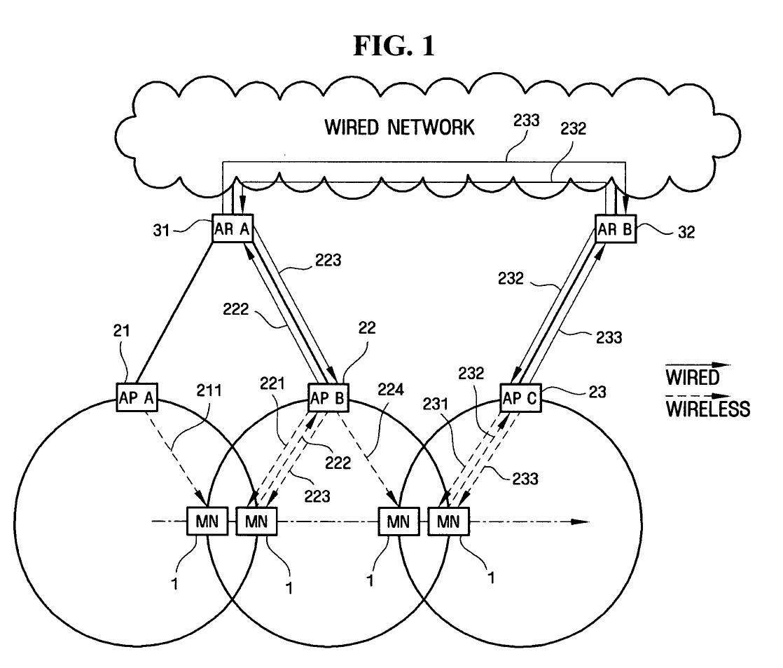

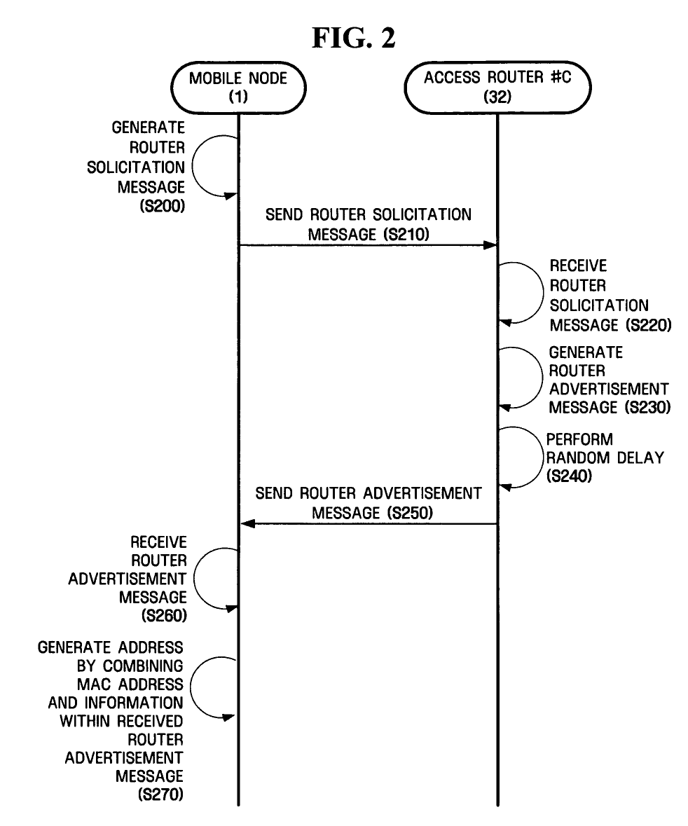

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

The invention, and exemplary aspects thereof, is described with reference to block diagrams or flowchart illustrations of a method and an apparatus to perform a fast handover according to exemplary embodiments of the invention, although the invention is not limited in this regard. It will be understood that each block of the flowchart illustrations, and combinations of blocks in the flowchart illustrations, can be implemented by computer program instructions, or other suitable software and/or firmware. These computer program instructions, or software, can be provided to, or implemented by, one or more of a processor of a general purpose computer, special purpose computer, or other programmable data processing apparatus, such as to produce a machine, and such that the instructions or software, which perform via the processor of the computer, or other suitable programmable data processing apparatus or processor, enable implementing the functions of the exemplary, or other, embodiments or aspects of the invention, such as illustrated in the flowchart block or blocks or herein described.

These computer program instructions, or software, can also be stored in a carrier wave, a computer usable or computer-readable memory, or other suitable memory, that can direct a computer, or other suitable programmable data processing apparatus or processor, to operate, such that the instructions, or software, stored in the computer usable or computer-readable memory provide an article of manufacture including instructional apparatus to implement the functions of the exemplary, or other, embodiments or aspects of the invention, such as illustrated in the flowchart block or blocks or herein described.

The computer program instructions, or software, can also be loaded into a computer, or other suitable programmable data processing apparatus or processor, to enable a series of operations to be performed on the computer, or other suitable programmable apparatus or processor, to provide a computer implemented operation such that the instructions, or software, that execute on a computer, or other suitable programmable apparatus or processor, provide operations to implement the functions of the exemplary, or other, embodiments or aspects of the invention, such as illustrated in the flowchart block or blocks or herein described. Also, each exemplary block of the flowchart illustrations can represent a module, segment, or a portion of code, for example, and can include one or more executable instructions to implement the described and/or illustrated logical function(s). Further, according to aspects of the invention, in alternative implementations and embodiments of the invention, the exemplary functions illustrated in the blocks can occur out of order or in a different order, and the invention is not limited in this regard. For example, two blocks illustrated in succession can be executed substantially concurrently or can be executed in a reverse order or other order, depending upon the functionality involved, according to aspects of the invention.

The terms “unit,” as used herein, indicates or refers to, but is not limited to, software or hardware components, such as a field programmable gate array (FPGA) or an application specific integrated circuit (ASIC), for example, which performs certain tasks according to aspects of the invention. Also, a unit can be configured to reside on an addressable storage medium and to perform on one or more processors, for example. A unit can include, by way of example, components, such as software components, object-oriented software components, class components and task components, processes, functions, attributes, procedures, subroutines, segments of program code, drivers, firmware, microcode, circuitry, data, databases, data structures, tables, arrays, and variables, and other suitable components, according to aspects of the invention. Further, according to aspects of the invention, the operations and/or functions of components and units can be combined into or implemented by fewer components and units or can be further separated into or implemented by additional components and units, and the invention is not limited in this regard. In addition, components and/or units, according to aspects of the invention, can be provided so as to reproduce, or implement, the operations of one or more central processing units (CPUs), or other suitable processor(s), within a device or a secure multimedia card, for example.

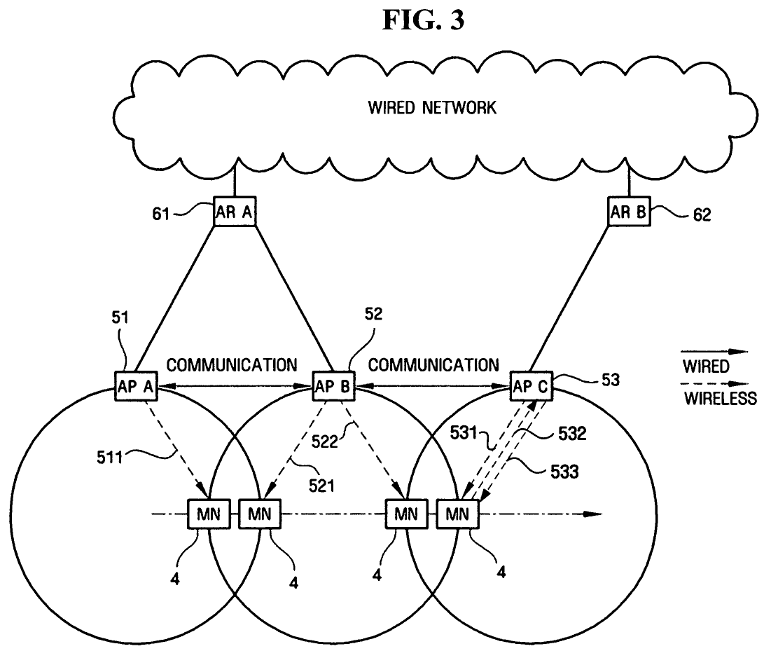

FIG. 3 illustrates wireless network environment according to an exemplary embodiment of the invention. Referring to FIG. 3, the wireless network environment includes a mobile node 4, an access point A 51, an access point B 52, an access point C 53, an access router A 61 and an access router B 62. In this regard, the mobile node 4 indicates a device that moves from one network to another network. When departing from a home link to an external link, the mobile node 4 is allocated an internet protocol (IP) address through a new link, thereby maintaining communications. The mobile node 4, according to aspects of the invention, can be a cell phone, notebook computer, personal digital assistant (PDA), or voice over internet protocol (VoIP) telephone, but the invention is not limited in this regard.

As illustrated in FIG. 3, the invention, and aspects thereof, will be described, by way of example, with respect to a case where the mobile node 4 sequentially passes through a basic service set (BSS) managed by the access point A 51 (hereinafter referred to as a “first wireless network”), a BSS managed by the access point B 52 (hereinafter referred to as a “second wireless network”) and a BSS managed by the access point C 53 (hereinafter referred to as a “third wireless network”). The access points A 51, B 52 and C 53 periodically transmit neighbor information in order to inform the mobile node 4 which access points provide an optimal wireless network environment to the mobile node 4. In this regard, the neighbor information indicates wireless resource information obtained from neighboring access points. While not required in all aspects, the neighbor information can contain information to indicate a BSS, and/or information to indicate a subnet, for example, and can contain other information.

The mobile node 4 within the first wireless network receives neighbor information from the access point A 51 denoted by a communication 511. In this regard, the neighbor information indicates information that the access point A 51 obtains from the access point B 52. The mobile node 4 selects an access point that can provide an optimal wireless network environment based on the received neighbor information. In FIG. 3, since the mobile node 4 is closer to the access point A 51 than to the access point B 52, the mobile node 4 selects the access point A 51 since the quality of the communication will typically be better. The mobile node 4 can join the wired network via the access point A 51 as it did previously. However, it is understood that the selection of an optimal wireless network environment can be otherwise determined, such as by signal strength, access cost(s), privacy and security concerns and/or by user selection, for example.

If the mobile node 4 is moved to the second wireless network, the mobile node 4 receives neighbor information from the access point B 52 denoted by a communication 521. In this regard, the neighbor information refers to information that the access point B 52 obtains from the access points A 51 and C 53. Based on the received neighbor information, the mobile node 4 selects an access point that can provide an optimal wireless network environment. In FIG. 3, since the mobile node 4 is closer to the access point B 52 than to the access point A 51, the mobile node 4 selects the access point B 52 since the communication quality is typically better. Accordingly, the mobile node 4 performs a handover due to the BSS change (i.e., due to a layer two or link layer (an L2) handover). In this regard and by way of example, the mobile node 4 selects the access point B 52 that can provide the optimal wireless network environment, and changes the connection with the access point A 51 to a connection with the access point B 52. The mobile node 4 can join the wired network via the access point B 52, which is different from the former case in which the mobile node 4 used the access point A 51.

When the mobile node 4 moves within the second wireless network, the mobile node 4 receives neighbor information from the access point B 52 denoted by a communication 522. In this regard, the neighbor information indicates information that the access point B 52 obtains from the access points A 51 and C 53. Based on the received neighbor information, the mobile node 4 selects an access point that can provide an optimal wireless network environment. In this regard and by way of example, the mobile node 4 selects the access point B 52 that typically can provide better communication quality because the mobile node 4 is relatively closer to the access point B 52 than to the access point C 53. The mobile node 4 joins the wired network by way of the access point B 52 as it did previously.

When the mobile node 4 within the second wireless network moves to the third wireless network, the mobile node 4 receives neighbor information from the access point C 53 denoted by a communication 531. In this regard and by way of example, the neighbor information indicates information that the access point C 53 obtains from the access point B 52. Based on the received neighbor information, the mobile node 4 selects an access point that can provide an optimal wireless network environment. In this regard and by way of example, the mobile node 4 selects the access point C 53 that can typically provide better communication quality since the mobile node 4 is relatively closer to the access point C 53 than to the access point B 52. Accordingly, the mobile node 4 performs a handover due to the BSS change (i.e., a handover in the link layer). In this regard, the mobile node 4 selects the access point C 53 because it can typically provide an optimal wireless network environment, and the mobile node 4 changes a link layer connection with the access point B 52 to a link layer connection with the access point C 53. The mobile node 4 joins the wired network by way of the access point C 53, which is different from the former case.

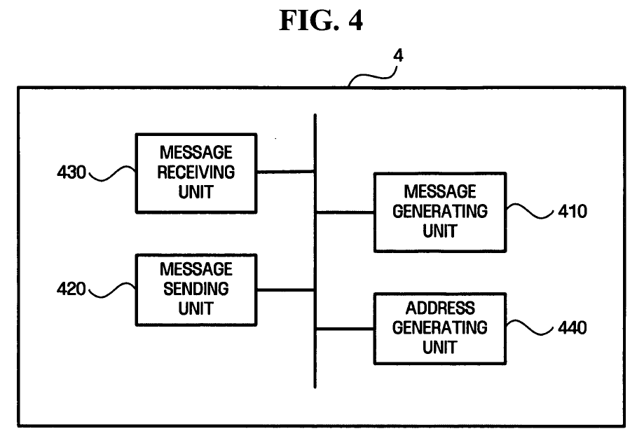

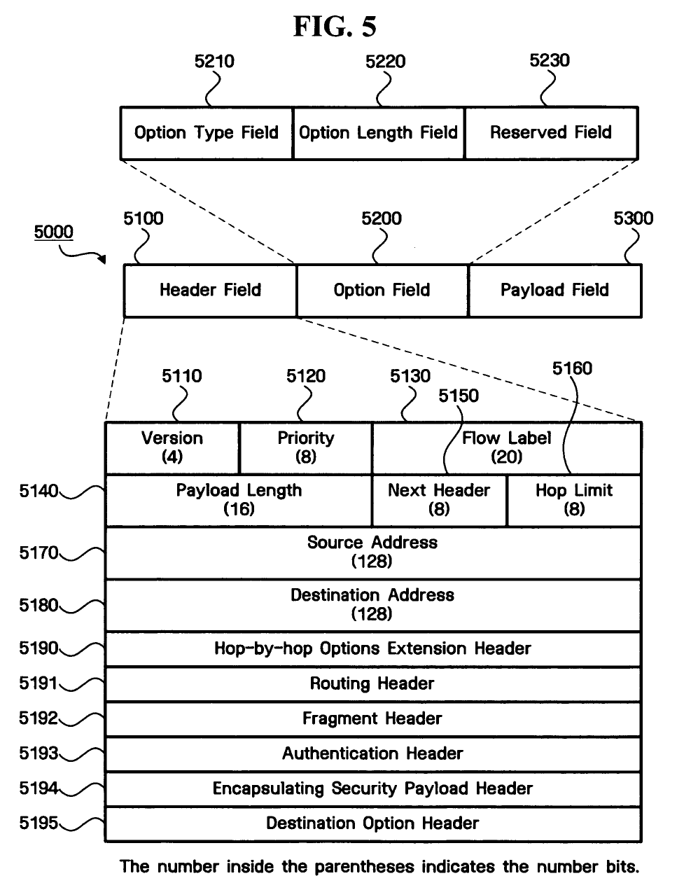

Further, the mobile node 4 can know that the mobile node 4 is transitioning into a new subnet based on the neighbor information denoted by the communication 531. Accordingly, the mobile node 4 performs a handover due to a change of the subnet (i.e., handover in the IP layer). To obtain new information necessary to set a new IP address, the mobile node 4 sends a router solicitation message to the access router B 62 denoted by a communication 532. While not required in all aspects, the router solicitation message sent by the mobile node 4 can include information to perform a fast handover, and a request asking the access router B 62 to send a router advertisement message, which will be further described with reference to FIGS. 4 and 5.

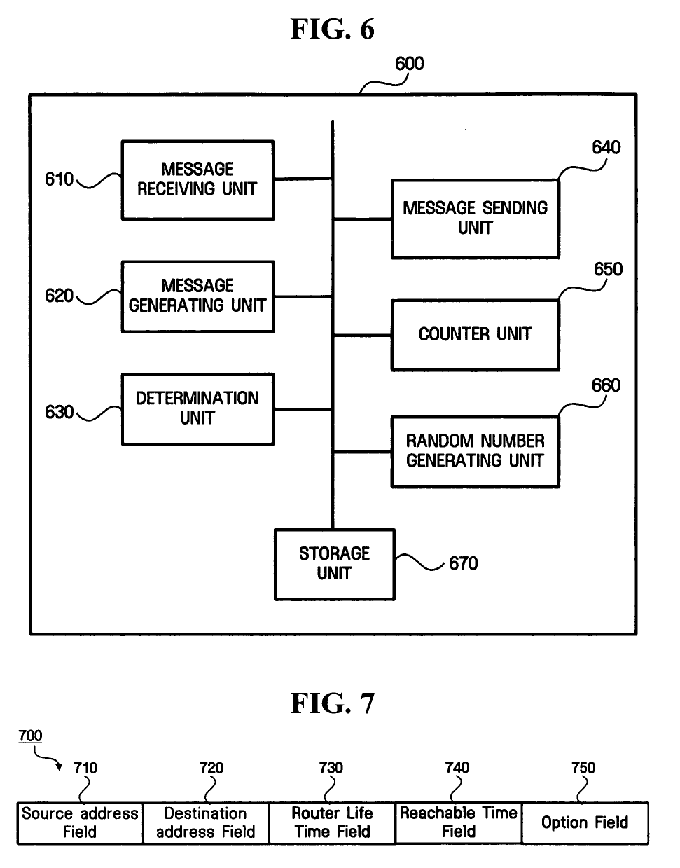

The access router B 62 that received the router solicitation message from the mobile node 4 generates a router advertisement message in response to the solicitation message and sends it to the mobile node 4 denoted by a communication 533. The access router B 62 selectively performs a random delay, as a result of checking the fast handover instruction information contained in the router solicitation message, and then transmits the router advertisement message to the mobile node 4 that sent the router solicitation message, which will be further described with reference to FIGS. 6 and 7.

FIG. 4 schematically illustrates a configuration of the mobile node 4 according to an exemplary embodiment of the invention. Referring to FIG. 4, the mobile node 4 includes a message generating unit 410, a message sending unit 420, a message receiving unit 430 and an address generating unit 440. The message generating unit 410 of the mobile node 4, as an example of a packet generating unit, generates a router solicitation (RS) message 5000 (FIG. 5) to request information to generate an address when the mobile node 4 participates in a new network (i.e., when the subnet has changed). The router solicitation message 5000 can include a source address, a destination address and/or fast handover instruction information, for example.

An exemplary format of the router solicitation message 5000 generated by the message generating unit 410 is explained with reference to FIG. 5. FIG. 5 illustrates the format of the router solicitation message 5000 generated by the message generating unit 410 according to an exemplary embodiment and aspects of the invention. Referring to FIG. 5, the router solicitation message 5000 typically includes a header field 5100, an option field 5200 and a payload field 5300. However, the fields of the router solicitation message 5000 need not be specifically so limited.

The header field 5100 has a total 40 bytes and includes a 4-bit version field 5110, an 8-bit priority field 5120, a 20-bit flow label field 5130, a 16-bit payload length field 5140, an 8-bit next header field 5150, an 8-bit hop limit field 5160, a 128-bit source address field 5170, a 128-bit destination address field 5180, a hop-by-hop option extension header field 5190, a routing header field 5191, a fragment header field 5192, an authentication header field 5193, an encapsulated security payload header field 5194 and a destination option header field 5195, for example.

Since the router solicitation message typically employs IPv6, the value of the version field 5110 is usually always 6. The value is recorded in the priority field 5120 and distinguishes a source packet, which supports flow control, from non-source packets. The value recorded in the flow label field 5130 sets properties of and requirements for a source and a destination. The payload length field 5140 records the size of the data, or a header length, after the 40-byte header field 5100.

The next header field 5150 can record a value to identify the presence of the option field extension header 5200. The hop limit field 5160 can prevent the permanent presence of a packet. The source address field 5170 records the address of the network device that sent the router solicitation message 5000 (e.g., the address of a mobile node, such as the mobile node 4, or other suitable network device), and the address of the network device, such as a router or other suitable network device, that is to receive the router solicitation message 5000 (e.g., a router address) is recorded in the destination address field 5180.

Various types of router information are recorded in the hop-by-hop option extension header field 5190 that are indicated in the extension header 5200. Information to prove, or confirm, an identity of the source is recorded in the authentication header field 5193, and information on encrypted content is recorded in the encapsulated security payload header 5194. The payload field 5300 indicates a field that records a message that requests information from a router. The size of the payload 5300 is typically recorded in the payload length field 5140 of the header field 5100.

The option field 5200 can be inserted after the header field 5100 described above in order to form an extension header. FIG. 5 also illustrates an exemplary format of the option field 5200 that can be added to the header 5100 of the router solicitation message 5000 according to an exemplary embodiment and aspects of the invention. Further, the option field 5200 typically includes an option type field 5210, an option length field 5220 and a reserved field 5230, for example.

Eight bits of the option header can be allocated for the option type field 5210 to record fast handover instruction information, for example. The fast handover instruction information indicates information to request a router to perform a fast handover function. In this regard, the fast handover instruction information typically allows a router that received a router solicitation message 5000 to selectively perform a random delay when the router generates a router advertisement message, in response to the router solicitation message 5000, and sends the router advertisement message. For example, when the value of the option type field 5210 is 100, a fast handover is requested, whereas a fast handover is not requested when the value of the option type field 5210 is 200, although the invention is not limited in this regard. The option type field 5210 can be used to identify the type of a network device, with the mobile node 4 being an example of a suitable network device, according to aspects of the invention, which sends a router solicitation message 5000 (e.g., to distinguish a mobile node, such as the mobile node 4, from a fixed node). In this regard, for example, the fixed node is relative to the mobile node 4, and indicates a network device within a predetermined network.

In this regard, for example, when the network device that sends the router solicitation message 5000 is a mobile node, such as the mobile node 4, the value 100 can be recorded in the option type field 5210. However, when the network device that sends the router solicitation message 5000 is a fixed node, the value 200 can be recorded in the option type field 5210. By varying the value of the option type field 5210 depending upon the type of network device, a router to which the router solicitation message 5000 is sent (e.g., the router A 61 or the router B 62) can apply a random delay according to the type of the network device. The option length field 5220 is typically 8 bits and records the size of the option field header 5200.

The message sending unit 420 of the mobile node 4, as an example of a packet sending unit, sends the router solicitation message 5000 generated in the message generating unit 410 to a router within the concerned network. For example, the message sending unit 420 sends the router solicitation message 5000 to the router B 62 within the third wireless network. The message receiving unit 430 of the mobile node 4, as an example of a packet receiving unit, receives a router advertisement message from a router within the concerned network, such as the router B 62, or receives a data packet sent from other mobile nodes or other suitable network devices. The message receiving unit 430 receives the router advertisement message from the router B 62 without a random delay time or after a predetermined random delay time, for example.

The address generating unit 440 of the mobile node 4, as an example of a determination unit, processes the router advertisement message received through the message receiving unit 430 and generates an IP address. In this regard, an IP address of a total 128 bits is generated using prefix information contained in the received router advertisement message and the media access control (MAC) address of the mobile node 4, for example.

In addition, the mobile node 4 can further include an input unit (not shown) to receive a command input by a user, or a display unit (not shown) to display the command input through the input unit or the result of processing the command. Also, the input unit and the display unit can be realized independently or in combination. The mobile node 4 can further include a storage unit (not shown) to store information received from the router or data received from other mobile nodes.

FIG. 6 illustrates a configuration of a router 600, with the router 600 being an example of a suitable network device, according to aspects of the invention, according to an exemplary embodiment of the invention, such as the router A 61 or the router B 62, for example. Referring to FIG. 6, the router 600 includes a message receiving unit 610, a determination unit 630, a message generating unit 620, a storage unit 670, a random number generating unit 660, a counter unit 650 and a message sending unit 640. When a router solicitation message, such as the router solicitation message 5000, is received through the message receiving unit 610 of the router 600, as an example of a packet receiving unit, the message generating unit 620 of the router 600, as an example of a packet generating unit, generates a router advertisement message 700 (FIG. 7) including information when the mobile node 4 generates an address. The router advertisement message 700 can include information such as a source address, a destination address, a router lifetime, a reachable time and a prefix, for example.

An exemplary format of the router advertisement message 700, such as generated by the message generating unit 620 of the router 600, is described with reference to FIG. 7. Referring to FIG. 7, the router advertisement message 700 includes, for example, a source address field 710 to record a link-local address of the router that sent the router advertisement message 700, a destination address field 720 to record the address of a mobile node, such as the mobile node 4, that is to receive the router advertisement message, a router life time field 730 to record the time during which the sender serves as a router, in a unit of seconds, for example, a reachable time field 740 to record the time that the router advertisement message 700 reaches the mobile node 4, in the unit of seconds, for example, and an option field 750 to record a link layer address or prefix information of the router.

The message receiving unit 610 of the router 600 receives the router solicitation message 5000 from the mobile node 4 and sends it to the determination unit 630. The determination unit 630 of the router 600, as an example of a determination unit, determines whether the router solicitation message 5000 has been received. When the router solicitation message 5000 has been received, the determination unit 630 checks the value of the fast handover instruction information contained in the received message 5000. As a result, when it is determined that a fast handover has not been requested, the determination unit 630 causes a random delay to be executed when the router advertisement message 700 is sent through the message sending unit 640. However, when the fast handover has been requested, the determination unit 630 performs the fast handover, to allow the router advertisement message to be sent to the mobile node 4 without the random delay being executed. In this regard, the router advertisement message 700 is sent to the mobile node 4 without the random delay.

The storage unit 670 of the router 600 can store the router advertisement message 700 generated by the message generating unit 620 or the router solicitation message 5000 received from the mobile node 4. The storage unit 670 can be implemented by a non-volatile memory such as read-only memory (ROM), programmable read-only memory (PROM), erasable programmable read only memory (EPROM), electrically erasable programmable read only memory (EEPROM), a volatile memory such as a random access memory (RAM) or a storage medium, such as a hard disk drive, or other suitable memory, and the storage unit 670 can be removable or internal, but the invention is not limited in this regard.

The random number generating unit 660 of the router 600 generates random numbers in a suitable range, such as the range of 0 to n (e.g., 0 to 500). A number generated in the random number generating unit 660 can be used as the random delay, or delay, when the router advertisement message 700 is sent, although the invention is not limited in this regard, as other suitable devices can provide a time delay according to aspects of the invention. For example, when the unit of time is milliseconds (ms) and the random number is 200, a 200 ms delay is used in the course of sending the router advertisement message 700. The counter unit 650 of the router 600 counts down the random number(s) generated in the random number generating unit 660. For example, when a random number generated by the random number generating unit 660 is 200, the counter unit 650 counts down from 200. When the count reaches 0, that is, a delay of 200 ms has occurred, the router advertisement message 700 can be sent to the mobile node 4 through the message sending unit 640 of the router 600, as an example of a packet sending unit.

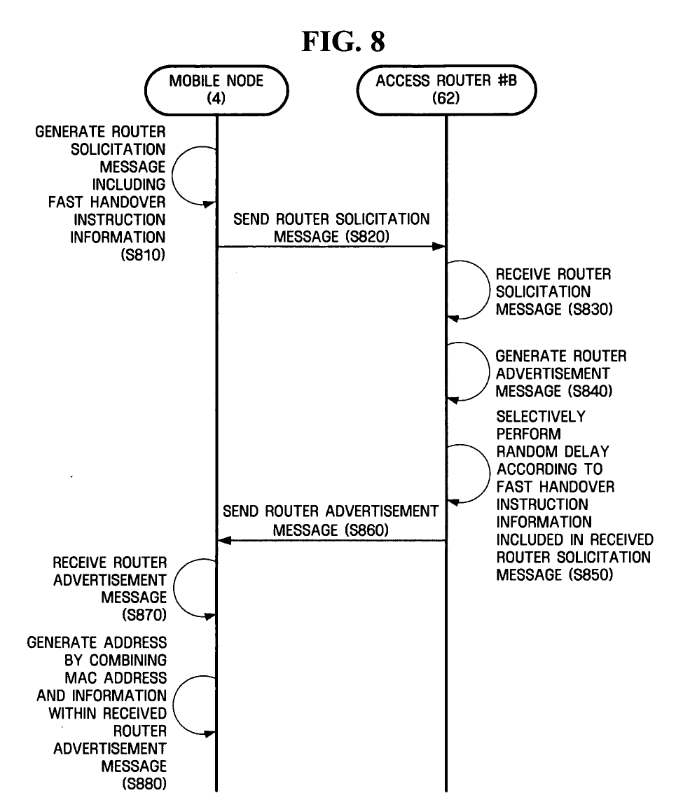

FIG. 8 illustrates a method of performing a fast handover according to an exemplary embodiment of the invention. Referring to FIGS. 3 through 8, to participate in the third wireless network through the first wireless network and the second wireless network, the mobile node 4 first generates a router solicitation message 5000 including fast handover instruction information through the message generating unit 410 at operation S810. For example, the mobile node 4 generates a router solicitation message 5000 having a value of 100 in the option type field 5200. The mobile node 4 sends the router solicitation message 5000 to the router 600 within the concerned network through the message sending unit 420 at operation S820.

The router 600, such as the router A 61 or the router B 62, receives the router solicitation message 5000 sent from the mobile node 4 through the message receiving unit 610 at operation S830. In response to the received router solicitation message 5000, the router 600 generates a router advertisement message 700 through the message generating unit 620 at operation S840. The router 600 checks the value of the fast handover instruction information contained in the router solicitation message 5000. After selectively performing a random delay according to the value of the fast handover instruction information at operation S850, the router 600 sends the router advertisement message 700 to the mobile node 4 at operation S860. For example, since the value of the fast handover instruction information is set 100, for example, as previously described, the router 600 sends the router advertisement message 700 to the mobile node 4 through the message sending unit 640, without performing a random delay at the operation S860.

After having received the router advertisement message 700 from the router 600, such as the router A 61 or the router B 62, at operation S870, the mobile node 4 generates an IP address using the information included in the received router advertisement message 700 at operation S880. In this regard, for example, a 128-bit IP address is generated, such as by combining prefix information included in the router advertisement message 700 and the MAC address of the mobile node 4.

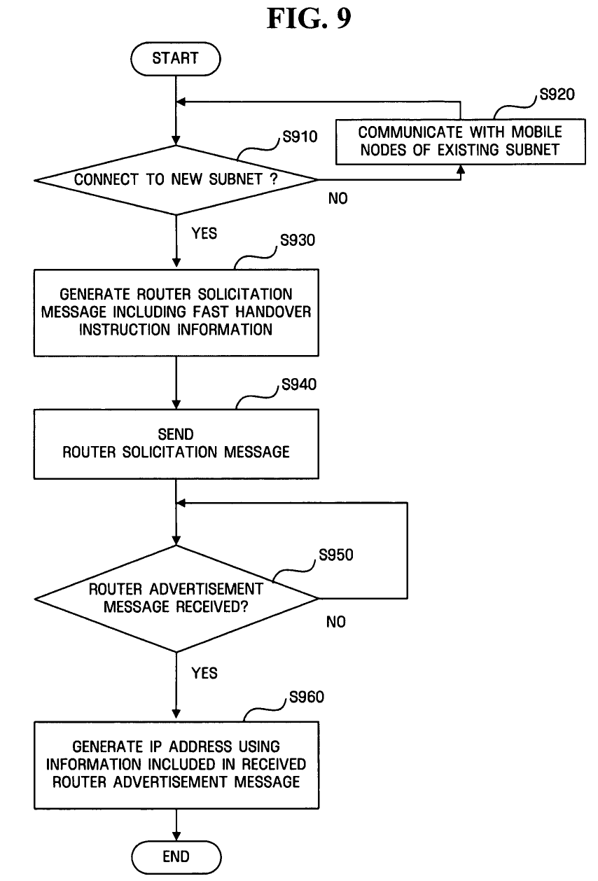

FIG. 9 is a flow chart illustrating the generation by the mobile node 4 of the router solicitation message 5000 in the fast handover according to an exemplary embodiment of the invention. Referring to FIGS. 3 through 7 and 9, the mobile node 4 determines whether it is in a new subnet from the information received through the message receiving unit 430 at operation S910. When the mobile node 4 determines that it is not connected to a new subnet, that is, the mobile node 4 resides in the same subnet, the mobile node 4 communicates with other mobile nodes through an access point, such as the access points A 51, B 52 or C 53, or a router 600, such as the router A 61 or the router B 62, within the concerned network at operation S920.

When the mobile node 4 determines that it is in a new subnet (e.g., when the mobile node 4 moves to the third wireless network through the second wireless network as illustrated in FIG. 3) at operation S910, the mobile node 4 generates a router solicitation message 5000 including fast handover instruction information using the message generating unit 410 at operation S930. For example, the mobile node 4 generates the router solicitation message 5000 with the fast handover instruction information set to 100. The mobile node 4 sends the router solicitation message 5000 to the router 600, such as the router B 62, within the new subnet through the message sending unit 420 at operation S940.

The mobile node 4 receives the router advertisement message 700 from the router 600, such as the router B 62, through the message receiving unit 430 (Yes of operation S950), or the mobile node 4 has not received a router advertisement message (No of operation S950). The mobile node 4 can receive, without the time delay, the router advertisement message 700 from the router 600, such as the router B 62, at operation S950 because the fast handover instruction information within the router solicitation message 5000 has a value to request a fast handover. The mobile node 4 that received the router advertisement message 700 from the router 600, such as the router B 62, processes the received router advertisement message 700 and generates an IP address at operation S960. In this regard, for example, the mobile node 4 generates a 128-bit IP address using the prefix information included in the router advertisement message 700 and the MAC address of the mobile node 4. The first 48 bits of the IP address are typically used for the MAC address, and the upper 64 bits of the IP address are typically used for the network prefix.

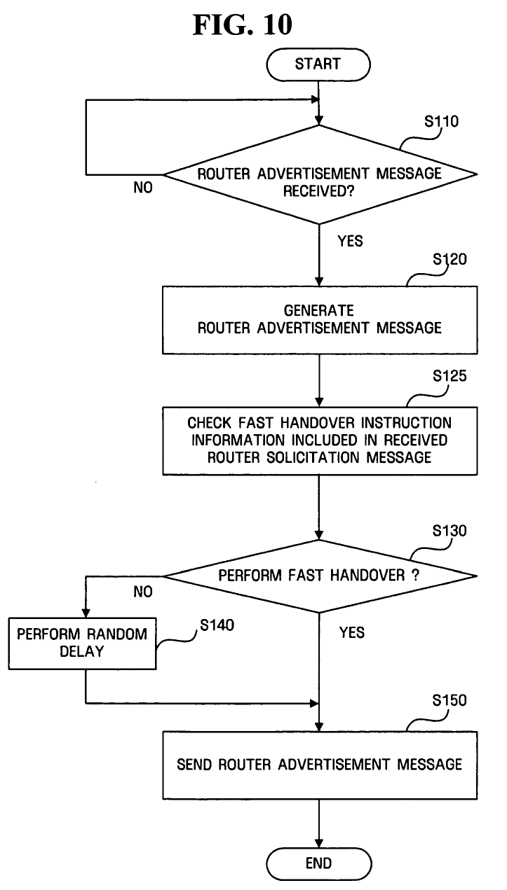

FIG. 10 is a flow chart illustrating the transmission by the router 600, such as the router A 61 or the router B 62, of the router advertisement message 700 in the fast handover according to an exemplary embodiment of the invention. Referring to FIGS. 3 though 7 and 10, the determination unit 630 of the router 600 determines whether the router solicitation message 5000 has been received through the message receiving unit 610 at operation S110.

When it is determined that the router solicitation message 5000 has not been received (No of operation S110), the router 600 waits until the router solicitation message 5000 is received from the mobile node 4. When the router solicitation message 5000 has been received (Yes of operation S110), the router 600 generates the router advertisement message 700 using the message generating unit 620 at operation S120. The router advertisement message 700 can include prefix information for the router 600 and the mobile node 4 to generate an address within the third wireless network. In response to generating the router advertisement message 700, the determination unit 630 of the router 600 checks the value of the fast handover instruction information included in the received router solicitation message 5000 at operation S125, and the router 600 determines whether to perform the fast handover at operation S130.

When it is determined that the fast handover instruction information included in the received message 5000 does not contain a value instructing a fast handover (No of operation S130) (e.g., when the value of the option type field 5210 in the router solicitation message 5000 is 200) the determination unit 630 of the router 600 performs a random delay at operation S140. In this regard, the router 600 generates a random number through the random number generating unit 660, and the counter unit 650 counts down the random number. For example, if the number generated by the random number generating unit 660 is 300, a countdown from 300 to 0 is performed, as the delay time, or random delay. That is, a delay corresponding to the generated random number is performed by the router 600. When the unit time is milliseconds (ms), for example, there will be a delay of 300 ms before the router advertisement message 700 is sent by the router 600. When the count reaches 0, the router 600 sends the router advertisement message 700 to the mobile node 4 through the message sending unit 640 at operation S150.

When it is determined that the fast handover instruction information included in the received message 5000 has a value instructing a fast handover (Yes of operation S130) (e.g., when the value of the option type field 5210 in the router solicitation message 5000 is 100) the determination unit of the router 600 sends, without the delay time, or without a random delay, the router advertisement message 700, generated using the message generating unit 620, to the mobile node 4 through the message sending unit 640 at operation S150.

As described above, the methods and the apparatus of performing a fast handover in wireless network according to the invention can provide the following, or other, effects, according to aspects of the invention. One effect, among effects, according to aspects of the invention, is that when a mobile node is moved to another subnet in the wireless network environment, a fast handover can be executed by minimizing a random delay generated in the course of obtaining information to generate an IP address. Another effect, among effects, according to aspects of the invention, is that the fast handover function can be supported by using an option field of a related search protocol, although a network manager does not typically make a separate setting for the router. A further effect, among effects, according to aspects of the invention, is that the fast handover function can be selectively supplied to the mobile node.

While described in terms of an access point, a router and a mobile node, it is understood that the access point, the router and/or the mobile node can be other network devices or elements, both mobile and non-mobile and, therefore, the node need not be mobile, and can also be a fixed node, for example. Further, according to aspects of the invention, selection of an optimal wireless network environment for a network device in performing a fast handover for the network device, such as a mobile node, relative to one or more network devices or network systems, such as one or more access points, routers and/or subnets, can be otherwise determined than by the network device passing or moving through one or more basic service sets or subnets, such as by relative motion or relative position between the network devices, signal strength, access cost(s), privacy and security concerns and/or by user selection, for example.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

1. A network device to perform a fast handover, the network device comprising:
a packet generating unit to generate a router solicitation message including fast handover instruction information, when the network device participates in a new subnet;
a packet sending unit to send the generated router solicitation message to a router within the subnet;
a packet receiving unit that receives a router advertisement message including information to generate an address from the router according to the fast handover instruction information; and
a determination unit to generate the address corresponding to the new subnet using the information.

2. The network device of claim 1, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

3. The network device of claim 2, wherein the option type field comprises the fast handover instruction information.

4. The network device of claim 3, wherein the fast handover instruction information comprises information to determine whether to perform a random delay when the router advertisement message is sent by the router.

5. A network device to perform a fast handover, the network device comprising:
a packet receiving unit to receive a router solicitation message including fast handover instruction information from a mobile node that participates in a subnet;
a packet generating unit to generate a router advertisement message including information to register an address of the mobile node in response to receiving the router solicitation message;
a determination unit to determine a value of the fast handover instruction information and to selectively perform a random delay to delay sending the router advertisement message, based on the value of the fast handover instruction information; and
a packet sending unit to send the router advertisement message to the mobile node.

6. The network device of claim 5, further comprising:
a random number generating unit to generate a random number within a predetermined range according to the value of the fast handover instruction information; and
a counter unit that uses the random number generated by the random number generating unit to delay transmission of the router advertisement message for a time corresponding to the random number.

7. The network device of claim 6, wherein the router advertisement message comprises at least one of a field to record a source address, a field to record a destination address, a field to record a router life time, a field to record reachable time, a field to record a prefix, or combinations thereof.

8. The network device of claim 7, wherein the fast handover instruction information comprises information to determine whether to perform a random delay when sending the router advertisement message.

9. A wireless network system, comprising:
at least one mobile node, which participates in a new subnet, the mobile node to generate a router solicitation message including fast handover instruction information, to send the router solicitation message, to receive a router advertisement message including information used to generate an address of the mobile node in response to the router solicitation message, and to generate an address of the mobile node in the new subnet; and
a router to receive the router solicitation message from the mobile node, to determine a value of the fast handover instruction information, to selectively perform a random delay to delay sending the router advertisement message to the mobile node, based on the value of the fast handover instruction information, and to send the router advertisement message to the mobile node.

10. The system of claim 9, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

11. The system of claim 10, wherein the option type field comprises the fast handover instruction information.

12. The system of claim 11, wherein the fast handover instruction information comprises information to determine whether to perform the random delay to delay sending the router advertisement message by the router.

13. A method of executing a fast handover in a wireless network, the method comprising:
generating a router solicitation message including fast handover instruction information;
sending the generated router solicitation message to a router within a subnet;
receiving a router advertisement message including information to generate an address from the router according to the fast handover instruction information; and
generating the address using the information in the received router advertisement message.

14. The method of claim 13, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

15. The method of claim 14, wherein the option type field comprises the fast handover instruction information.

16. The method of claim 15, further comprising:
selectively performing a random delay to delay sending the router advertisement message according to the fast handover instruction information in response to receiving the router solicitation message.

17. A method of executing a fast handover in a wireless network, the method comprising:
receiving a router solicitation message including fast handover instruction information from a mobile node participating in a new subnet;
generating a router advertisement message including information to register an address of the mobile node in response to the received router solicitation message;
checking the fast handover instruction information in the received router solicitation message;
selectively executing a random delay to delay sending the router advertisement message, based on the checked fast handover instruction information; and
sending the router advertisement message to the mobile node.

18. The method of claim 17, wherein the mobile node generates an internet protocol (IP) address using information included in the router advertisement message.

19. The method of claim 18, wherein when the mobile node is moved to the new subnet in a wireless network environment, executing the fast handover by minimizing the random delay generated in obtaining information to generate the IP address.

20. The method of claim 17, wherein the fast handover instruction information comprises information to determine whether to execute the random delay to delay sending the router advertisement message.

21. The method of claim 17, wherein selectively executing the random delay further comprises:
generating a random number within a predetermined range according to a value of the fast handover instruction information; and
counting a delay time to delay sending the router advertisement message for a time corresponding to the random number.

22. The method of claim 17, further comprising:
generating the router solicitation message including the fast handover instruction information by the mobile node;
sending the generated router solicitation message to a router within the new subnet;
receiving by the mobile node the router advertisement message including the information to register the address of the mobile node from the router according to the fast handover instruction information; and
generating by the mobile node the address of the mobile node using the information in the received router advertisement message.

23. The method of claim 22, wherein selectively executing the random delay further comprises:
generating a random number within a predetermined range according to a value of the fast handover instruction information; and
counting a delay time to delay sending the router advertisement message for a time corresponding to the random number.

24. The method of claim 22, further comprising:
supporting the fast handover using an option field of a related search protocol.

25. The method of claim 17, wherein when the mobile node is moved to the new subnet in a wireless network environment, executing the fast handover by minimizing the random delay generated in obtaining information to generate an internet protocol (IP) address.

26. The method of claim 17, further comprising:
supporting the fast handover using an option field of a related search protocol.

27. A network system to perform a fast handover, the network system comprising:
a first network device, comprising:
a first packet generating unit to generate a router solicitation message including fast handover instruction information, when the first network device participates in a new subnet;
a first packet sending unit to send the generated router solicitation message to a second network device within the new subnet;
a first packet receiving unit that receives from the second network device a router advertisement message including information to generate an address of the first network device according to the fast handover instruction information; and
a first determination unit to generate the address of the first network device corresponding to the new subnet using the information; and
a second network device, comprising:
a second packet receiving unit to receive the router solicitation message including the fast handover instruction information from the first network device;
a second packet generating unit to generate the router advertisement message including the information to generate the address of the first network device in response to receiving the router solicitation message;
a second determination unit to determine a value of the fast handover instruction information and to selectively perform a random delay to delay sending the router advertisement message, based on the value of the fast handover instruction information; and
a second packet sending unit to send the router advertisement message to the first network device.

28. The network system of claim 27, wherein the second network device further comprises:
a random number generating unit to generate a random number within a predetermined range according to the value of the fast handover instruction information; and
a counter unit that uses the random number generated by the random number generating unit to delay sending the router advertisement message for a time corresponding to the random number.

29. The network system of claim 27, wherein the router advertisement message comprises at least one of a field to record a source address, a field to record a destination address, a field to record a router life time, a field to record reachable time, a field to record a prefix, or combinations thereof.

30. The network system of claim 29, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

31. The network system of claim 30, wherein the option type field comprises the fast handover instruction information.

32. The network system of claim 27, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

33. The network system of claim 32, wherein the option type field comprises the fast handover instruction information.

34. The network system of claim 27, wherein the fast handover instruction information comprises information to determine whether to perform the random delay when sending the router advertisement message.

35. The network system of claim 27, wherein:
the first network device comprises a mobile node, and
the second network device comprises a router.

36. A network device to perform a fast handover, the network device comprising:
a message generating unit to generate a router solicitation message including fast handover instruction information, when the network device participates in a new subnet;
a message sending unit to send the generated router solicitation message to a second network device within the new subnet;
a message receiving unit that receives from the second network device a router advertisement message including information to generate an address of the network device according to the fast handover instruction information; and
an address generating unit to generate the address of the network device corresponding to the new subnet using the information.

37. The network device of claim 36, wherein the router advertisement message comprises at least one of a field to record a source address, a field to record a destination address, a field to record a router life time, a field to record reachable time, a field to record a prefix, or combinations thereof.

38. The network device of claim 37, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

39. The network device of claim 38, wherein the option type field comprises the fast handover instruction information.

40. The network device of claim 38, wherein:
the network device comprises a mobile node, and
the second network device comprises a router.

41. The network device of claim 36, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

42. The network device of claim 41, wherein the option type field comprises the fast handover instruction information.

43. The network device of claim 42, wherein:
the network device comprises a mobile node, and
the second network device comprises a router.

44. The network device of claim 36, wherein:
the network device comprises a mobile node, and
the second network device comprises a router.

45. A network device to perform a fast handover, the device comprising:
a message receiving unit to receive a router solicitation message including fast handover instruction information from a second network device;
a message generating unit to generate a router advertisement message including information to generate an address of the second network device in response to receiving the router solicitation message;
a determination unit to determine a value of the fast handover instruction information and to selectively perform a random delay to delay sending the router advertisement message, based on the value of the fast handover instruction information; and
a message sending unit to send the router advertisement message to the second network device.

46. The network device of claim 45, wherein:
the network device comprises a router, and
the second network device comprises a mobile node.

47. The network device of claim 45, wherein the router advertisement message comprises at least one of a field to record a source address, a field to record a destination address, a field to record a router life time, a field to record reachable time, a field to record a prefix, or combinations thereof.

48. The network device of claim 45, wherein the router solicitation message comprises:
a header field comprising at least one of a field to record a version of the message, a field to record a header length, a field to record a source address, a field to record a destination address, or combinations thereof;
an option field comprising at least one of a field to record an option type, a field to record an option length, a reserved field, or combinations thereof; and
a payload field to record message information.

49. The network device of claim 48, wherein the option type field comprises the fast handover instruction information.

50. The network device of claim 48, wherein:
the network device comprises a router, and
the second network device comprises a mobile node.

51. The network device of claim 45, wherein the network device further comprises:
a random number generating unit to generate a random number within a predetermined range according to the value of the fast handover instruction information; and
a counter unit that uses the random number generated by the random number generating unit to delay sending the router advertisement message for a time corresponding to the random number.

52. The network device of claim 51, wherein:
the network device comprises a router, and
the second network device comprises a mobile node.

53. The network device of claim 51, wherein the network device further comprises:
a storage unit to store one or more of the router advertisement message or the router solicitation message.

54. The network device of claim 53, wherein:
the network device comprises a router, and
the second network device comprises a mobile node.

55. A computer-readable recording medium having embodied thereon a computer program to execute by a processor a method of executing a fast handover in a wireless network, the fast handover method embodied in the program comprising:
generating a router solicitation message including fast handover instruction information;
sending the generated router solicitation message to a network device within a subnet;
receiving from the network device a router advertisement message including information to generate an address from the network device according to the fast handover instruction information; and
generating the address using the information in the received router advertisement message.

56. The computer-readable recording medium of claim 55, wherein:
the network device comprises a router.

57. A computer-readable recording medium having embodied thereon a computer program to execute by a processor a method of executing a fast handover in a wireless network, the fast handover method embodied in the program comprising:
receiving a router solicitation message including fast handover instruction information from a network device participating in a new subnet;
generating a router advertisement message including information to register an address of the network device in response to the router solicitation message;
checking the fast handover instruction information in the received router solicitation message; and
selectively executing a random delay to delay sending the router advertisement message, based on the checked fast handover instruction information; and
sending the router advertisement message to the network device.

58. The computer-readable recording medium of claim 57, wherein:
the network device comprises a mobile node.
